(19) United States
(12) Patent Application Publication
(10) Pub. No.: US 2010/0287231 A1
(43) Pub. Date: Nov. 11, 2010

(54) METHOD AND APPARATUS FOR CERTIFYING HYPERLINKS

(75) Inventors: Larry J. Hughes, JR., Mercer Island, WA (US); Fabian Pustelnik, Neuquen (AR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ESIGNET, INC., Bellevue, WA (US)

(21) Appl. No.: 12/617,682

(22) Filed: Nov. 12, 2009

Related U.S. Application Data
(60) Provisional application No. 61/113,511, filed on Nov. 11, 2008.

(51) Int. Cl. G06F 15/16

(52) U.S. Cl. 709/203

(57) ABSTRACT

The technology disclosed relates to certifying a hyperlink. A declarant desires to publish a plurality of facts it asserts about a hyperlink's destination anchor. The declarant constructs a formatted digital declaration of facts and presents it to a certifier requesting a signed declaration of facts. The certifier examines the declaration in accordance with its operating policy and assembles a signed declaration of facts indicating its confidence that the facts are true. A client encounters a hyperlink of interest and requests information from the certifier about the facts and the certifier's confidence that the facts are true. The certifier presents its signed declaration of facts and confidence to the client in a manner such that the client can render the facts and confidence information prior to the user clicking or selecting the hyperlink.

### CROSS-REFERENCE(S) TO RELATED APPLICATION(S)

This application claims the benefit of U.S. Provisional Application No. 61/113,511, filed Nov. 11, 2008, which is herein incorporated by reference in its entirety.

### BACKGROUND

Hyperlinks are the foremost defining characteristic of hypermedia. They weave together hypermedia objects for the purposes of navigation. Each hyperlink has a source anchor (“here”) and a destination anchor (“there”). For a user running a visually interactive hypermedia application, source anchors are typically represented as clickable areas within an application window. The destination anchor, expressed as a Universal Resource Locator (URL), is usually visually masked behind the source anchor.

For simplicity of understanding the disclosed technology, this specification uses five abbreviated terms. Unless otherwise indicated, the abbreviated terms are used in a manner as would be understood by those of ordinary skill in the art but are described here to aid the reader.

1. The term document means any hypermedia object addressed by a destination anchor, including web pages. Documents might be of fixed size and static as with a web page served unchanged from a web server's document folder, continuous as with streaming a live videocast, dynamic as with a page programmatically constructed in real time using data from a database.

2. The term user means a human interactively operating a computer.

3. The term computer means a wired or wirelessly networked device having a CPU, memory, internal and/or external persistent storage, running an operating system and software applications, and possibly having a screen, keyboard, mouse, or their functional equivalents. Applicable computer types include laptops and their desktop equivalents, racked servers, smart phones, PDAs, set-top boxes, game players, music players.

4. The term click, aside from its expected meaning, includes actions taken by a user to select an item presented in a graphical user interface. Other than a conventional mouse click, such actions include other stimulatory actions that trigger a so-called click event, such as pressing the enter key, or with the proper interfaces, touching a screen, voicing a command, nodding a head, blowing into a tube, and so on.

5. The term link means a hyperlink.

Examining the history and current nature of hypermedia, it is clear that they were designed to operate—and still operate today—under several implicit assumptions highly pertinent to the disclosed technology. First, there is the assumption that users authoring hypermedia create links that accurately and adequately represent what lies beyond them. And second, there is the assumption that users authoring hypermedia create links that pose no threat to the end users. Recent history teaches us that neither assumption is true, and far from it.

The disclosed technology addresses the threat of fraud presented to users as a direct result of clicking on a link. Simply put, a user clicks on a fraudulently deceptive hyperlink, naively expecting a benign result, and unsuspectingly experiences a malevolent one. To date, two distinct classes of post-click threats have become common to the Internet experience. Given that the second to emerge overtook the first relatively rapidly, this suggests more may be latent. The two identified classes are phishing and drive-by malware. These are discussed at length in literature elsewhere, so we only provide a distilled picture here. With phishing, a user clicks on a hyperlink and lands on a fraudulent site that visually dupes the user into surrendering information of personal value, for example, login credentials used to access his bank account online. With drive-by malware, a user clicks on a hyperlink, is taken to a page lacking visual content but containing a script that hijacks their computer, and is then HTTP redirected to land on the expected legitimate page.

As is becoming clear, there are significant risks posed to virtually every entity participating in earnest on the Web, including individuals, businesses, non-profits and even governments and militaries. Given these risks there is a need for a system that alerts users to fraud prone links that are known to be legitimate.

### SUMMARY

To address the above mentioned problem and others, the technology disclosed herein is a system for providing information to a user about a hyperlink before they click on the hyperlink. In one embodiment, the system alerts a user to certified hyperlinks that have facts associated with them and a confidence value that indicates a certifier's confidence that the facts are true.

Software running on a client's computer detects a certified hyperlink and provides the facts and the confidence values to the user before the user clicks on the hyperlink.

In one embodiment, the certifier is a server computer. A declarant registers with the certifier with a self-chosen strength of authentication. Upon registration, the declarant provides facts to be associated with a hyperlink and the certifier produces a signed declaration of the facts along with a confidence value related to the strength of authentication or other factors.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of an environment where a user may encounter a fraudulent hyperlink;

FIG. 2 is a system for alerting a user to certified hyperlinks in accordance with an embodiment of the disclosed technology;

FIG. 3A illustrates how a declarant registers with a certifier in accordance with one embodiment of the disclosed technology;

FIG. 3B illustrates how a user's client registers with a certifier in accordance with one embodiment of the disclosed technology; and

FIG. 4 is a flowchart of the steps performed by a client computer to retrieve a signed declaration of the facts associated with a certified hyperlink; and

FIG. 5 illustrates a screen shot of signed declaration of the facts presented to a user.

### DETAILED DESCRIPTION

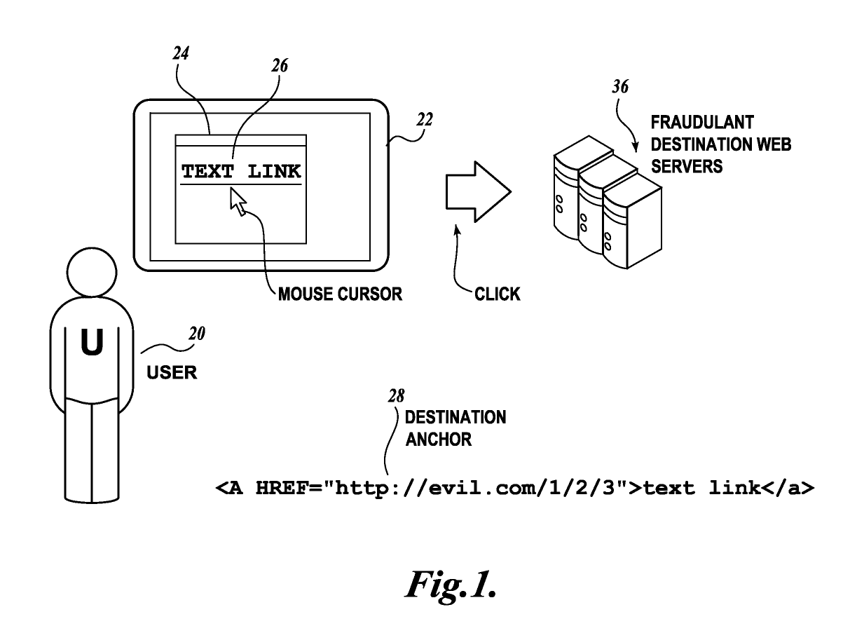

FIG. 1 shows an example environment where a user 20 with their computer 22 is likely to experience a fraudulent hyperlink. The user 10 surfs the Internet and encounters a web page 24 that includes the hyperlink 26. The web page includes an anchor tag 28 that specifies an anchor destination defined by the URL “evilbank.com”, and shows the user a destination anchor text as “yourfriendlybank.com”. Upon clicking on the hyperlink 26, the users' client computer is taken a fraudulent web page 36 that the user may think is yourfriendlybank.com but is not.

Prior techniques used to alert the user 10 that a hyperlink may be fraudulent include services that receive report of fraudulent hyperlinks which are added to blacklists Software on the user's computer determines if a hyperlink is on the blacklist either on a local file or by sending a request to a remote server. Other techniques include software that scours the Internet looking for fraudulent or malevolent content. Hyperlinks associated with such fraudulent or malevolent content are added to blacklists. The technology disclosed herein is an alternate and complementary technique for alerting users to potential fraudulent hyperlinks and in particular to techniques that alert users to such hyperlinks before clicking or selecting the hyperlink.

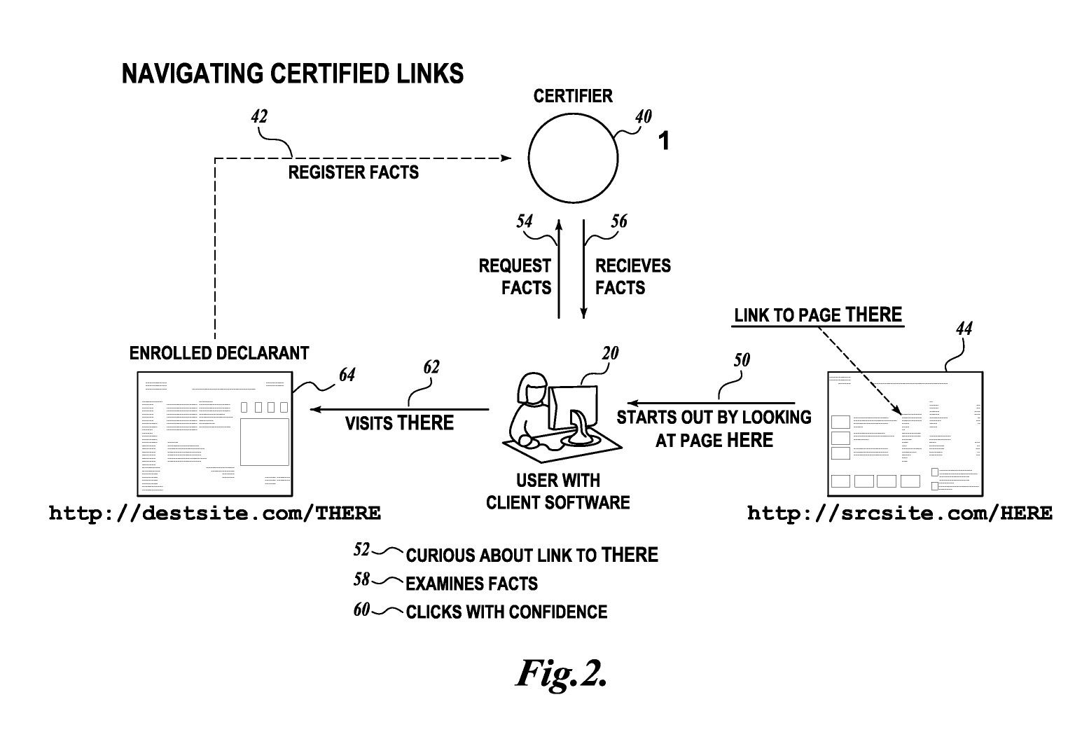

FIG. 2 shows one embodiment of a system for informing a user of a certified hyperlink in accordance with an embodiment of the disclosed technology. A certifier 40, which is implemented as a web-based sever computer, receives a request 42 from a declarant to register one or more facts associated with a hyperlinks. The certifier 40 performs due diligence on the facts and stores the facts and its confidence that the facts are true for use by clients.

The user 20 at 50 surfs the Internet with their client computer and encounters a web page 44 with one or more certified hyperlinks in it. At 52 the user is curious about a certified hyperlink. The user indicates their curiosity about the certified hyperlink by, for example, placing their mouse pointer over the certified hyperlink. Software on the user's computer recognizes that the user is interested in the certified hyperlink and sends a request at 54 asking if the certifier 40 has a signed declaration of the facts for the hyperlink. At 56, the certifier 40 returns the signed declaration including the facts given to it by the declarant along with the certifier's confidence that the facts are true. At 58, the user examines the facts, and if the user feels secure, the user can click the certified hyperlink at 60. The user's computer is connected at 62 to a website 64 defined by the destination anchor URL specified by the certified hyperlink.

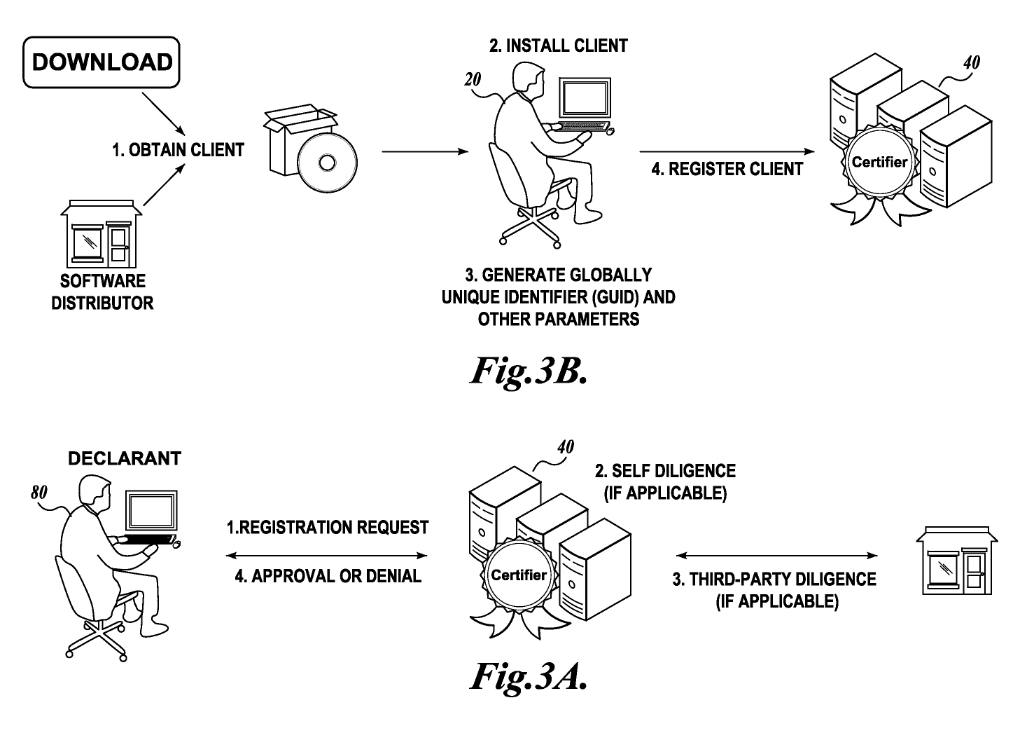

FIG. 3A shows the steps performed by a certifier 40 under program control to certify a hyperlink. A declarant 80 obtains a declarant software kit that when installed on their computer begins a registration process with the certifier 40. In one embodiment, the installation process:

generates the claimant's GUID (global unique identifier);

generates its asymmetric keypair;

generates a self-signed authentication certificate containing the generated GUID;

gathers version numbers of the declarant's computer's operating system, shared libraries and other runtime foundations;

gathers the version numbers any client-supported applications (e.g., web browsers, email clients);

gathers computer hardware parameters helpful for troubleshooting;

prompts the declarant to select one or more means of authentication having various strengths to be used when managing its declarations of facts with the certifier. Options include:
None (i.e. the declarant provides no authentication credentials),
Weak (e.g. the declarant provides its e-mail address),
Strong (e.g. the declarant provides a symmetric key)
Maximum (e.g. the declarant asymmetrically encrypts a nonce provided by the certifier using the declarant's private key associated with an Extended Validation SS certificate already in its possession)
Manual (e.g. the certifier checks various third sources to confirm the identity of the declarant after which the remainder of the registration process is completed manually)

Next, the registration software kit causes the computer of the declarant to assemble the above information into a declarant registration message and transmit it to the certifier 40, after first verifying that the certifier's own authentication certificate descends from the same root of the one bundled in the declarant software kit.

Upon receipt of the declarant registration message, the certifier does diligence to confirm the identity of the declarant. In one embodiment, the certifier's diligence is performed in accordance with the declarant's chosen strength of authentication. If Manual authentication is selected then the registration process is completed when the diligence is completed. If Maximum authentication is selected then the certifier verifies that the nonce was correctly encrypted by the declarant. If not, registration is not completed.

The certifier 40 executes program instructions to respond with the declarant's own authentication certificate, now countersigned by the certifier 40, along with any executable files, configuration files and other items needed for runtime.

Henceforth, whenever the declarant communicates with certifier, the declarant mutually authenticates the channel with the declarant's authentication certificate. In addition, the declarant uses one of his selected means to authenticate himself for a given communication.

Once registered, the declarant is free to assert facts about hyperlinks. In one embodiment, the declarant selects a hyperlink to be certified. Next, software on the declarant's computer assembles one or more facts to be associated with the hyperlink. For example, such facts could include site information such as the name and address of the declarant, the date of its domain name registration, the date of the first appearance of content on its site, the validity period for its SSL certificates. The facts should also include page specific information such as the precise chain of HTTP re-directs that the application will follow between a click and the application landing on a final destination at the end of the chain. The facts can also contain information about how many sources provide content to a mashup page, who they are, and the nature of their content. Also the facts may include the date the page will expire and/or revision history of the page.

The declarant's computer submits a certification request message to the certifier specifying the hyperlink and the one or more facts, either through the certifier's extranet (if one exists) or through software provided with the declarant's software kit. The message is sent using one of the means of authentication the declarant selected during its registration process.

Upon receipt of the message, the certifier 40 evaluates the request, taking into account its policy, the scope of the claim, and the claimant's means of authentication. The certifier 40 executes instructions to determine its confidence in the facts and certifies the facts in accordance with the certifier's confidence that the facts are true, by digitally signing the declaration. The confidence values may be indicators such as Absolute, High, Moderate, Low, None etc. or other values that are meaningful to a user. In one embodiment, the confidence values are a function of the strength of authentication. For example, a Maximum confidence value is given to facts from a declarant's high authentication strength. The certifier stores the digitally signed declaration of facts in a database. The certifier sends an acknowledgement message to the declarant with a copy of the signed declaration, which the declarant is free to distribute or not. The policy of the certifier is a statement of rules and procedures that it will follow when vetting the identity of declarants and the rules and procedures it will use to certify facts about hyperlinks.

In one embodiment, a declarant may also request that the certifier decertify a hyperlink by sending a message to the certifier. Upon receipt of the message, the certifier 40 evaluates the request, taking into account its policy, the scope of the claim, and the declarant's means of authentication. The certifier marks the status of the certified hyperlink as decertified in a database and sends an acknowledgement message to the declarant.

FIG. 3B shows steps performed to register a user 20 with the certifier 40. In one embodiment, a user obtains client software kit with software that:

generates the client's GUID (global unique identifier);

generates an asymmetric keypair;

generates a self-signed authentication certificate containing the generated GUID;

gathers version numbers of the client's computer's operating system, shared libraries and other runtime foundations;

gathers the version numbers any client-supported applications (e.g., web browsers, email clients);

gathers computer hardware parameters helpful for troubleshooting;

Unless the user desires anonymity, the client software kit prompts the user for a unique authentication credentials e.g. user name, password, etc.

Next, the client software kit assembles the above information into a client registration message and transmits it to the certifier 40, after first verifying that the certifier's own authentication certificate descends from the same root of the one bundled in the client software kit.

Upon receipt of the client's registration message, the certifier 40 responds with the client's own authentication certificate, now countersigned by the certifier 40, along with any executable files, configuration files and other items needed for runtime.

Henceforth, whenever the client communicates with certifier, it mutually authenticates the channel with the client's authentication certificate. In addition, the user uses the credentials he supplied during the registration process to authenticate himself for a given communication.

In one embodiment, the user is provided with one or more plug-ins for one or more hypermedia-aware applications to detect certified hyperlinks and provide facts associated with the certified hyperlinks. For example, plug-ins are provided for web browsers, e-mail clients, spreadsheets, word processing programs, drawing programs, document viewers, presentation programs etc.

In one embodiment of the disclosed technology, the plug-in recognizes a certified hyperlink through one or more of several methods such as by asking the certifier if the certifier has a signed declaration of facts for the hyperlink in question.

Alternatively, the plug-in can first determine if the hyperlink can be ruled out prior to querying the certifier. For example, not all applications need concern themselves with all certified hyperlinks. A given application might need to regard only HTTPS destinations and no others (e.g. HTTP, FTP). It may be wasteful to attempt resolution of any others. The client allows for an artificial reduction in the set of potentially certified hyperlinks. It accomplishes this by applying a series of configurable regular expressions against destination URLs. Those that match one of the expressions are regarded as potentially certified, all others not. Returning to the HTTPS example, the set of potentially certified hyperlinks are those whose URLs match the regular expression “̂HTTPS://.*” (assuming URLs are normalized to upper case). Such regular expressions can be used to rule out hyperlinks with destinations in the .edu top level domain for example.

In some embodiments, an application may maintain its own record of hyperlinks previously encountered that were certified. The record can then be consulted to determine if a hyperlink is certified in lieu of or in addition to the other methods described.

Although the above description describes determining if a single hyperlink is certified, the plug-in may determine if a number of hyperlinks are certified.

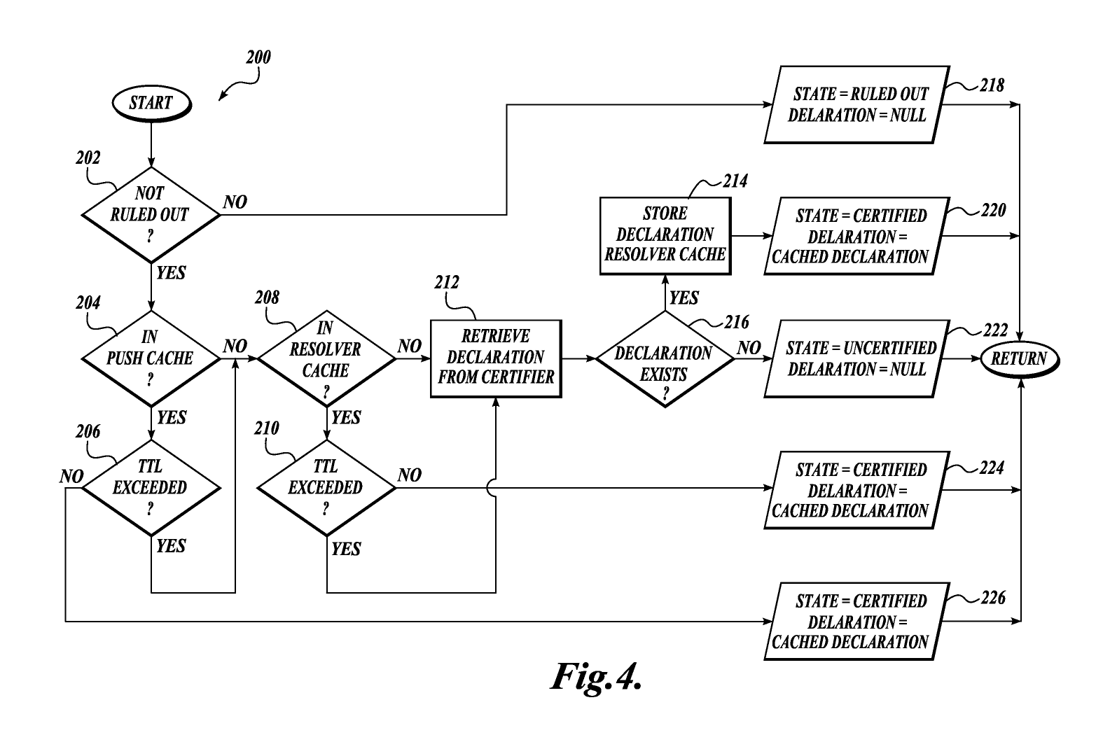

FIG. 4 is a flowchart of steps performed by a plug-in to retrieve a signed declaration of facts associated with a certified hyperlink. Beginning at 202 the plug checks to see if the hyperlink should be ruled out based on regular expression matching as described above. At 204, the plug-in checks to see if the certifier has previously pushed the signed declaration of facts into the client's push cache. If so, the plug-in checks to see if the time-to-live is exceeded at 206. If so, then the processing proceeds to 208 where the plug-in checks to see if the signed declaration of facts is in the resolver cache. If so, the plug-in checks to see if the time-to-live is exceeded at 210. If so, then processing proceeds to 212 where the plug-in sends a message to the certifier requesting the signed declaration of facts.

If the answer at 202 was no, and the hyperlink should be ruled out, then processing proceeds to 218 where the plug-in returns a state value of “ruled out” and a declaration value of null.

If the signed declaration is not in the push cache at 204, then processing proceeds to 208 where the plug-in checks to see if the signed declaration is in the resolver cache. If so processing proceeds to 210 as indicated above.

If the answer to 206 is no, then processing proceeds to 226, where the plug-in returns a state value of “certified” and declaration value of the cached declaration.

At 222 the plug-in returns a state value of “un-certified” and a declaration value of null.

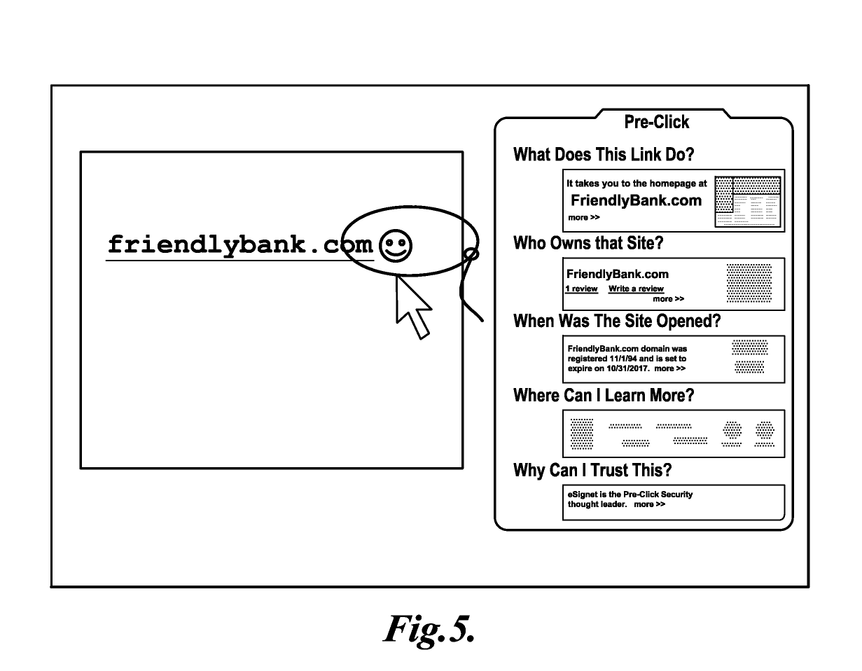

Upon receipt of a signed declaration of facts either from the certifier or from a push or resolver cache, the plug-in produces an image/icon juxtaposed with the source anchor of the hyperlink that indicates to the user that the hyperlink is certified. In one embodiment, upon installation, the client software kit creates a widget that is docked to the client computer's desktop. When the user sees the juxtaposed image/icon, the user drags the docked widget from the desktop over the application and window and drops it on top of the image/icon to produce a separate window that is visually distinct from the underlying application as illustrated in FIG. 5. The facts associated with the certified hyperlink are rendered in the new window. Upon seeing the facts, the user can determine if he wants to click on the hyperlink. The facts are displayed to the user prior to the user clicking on the certified hyperlink.

While illustrative embodiments have been illustrated and described, it will be appreciated that various changes can be made therein without departing from the spirit and scope of the invention. For example, it is possible to have many certifiers which operate autonomously or cooperatively, with each operating under their own policies. Multiple certifier can set up their own trust relationships among themselves and clients are permitted to query any number of certifiers to determine and with their unique degrees of confidence about the facts associated with a hyperlink and apply its own decision logic to determine its course of action.

The embodiments of the invention in which an exclusive property or privilege is claimed are defined as follows:

1. A server computer system for providing facts and confidence information about hyperlink destination anchors, comprising:
a memory that stores confidence information for one or more facts associated with a declarant subscriber and one or more associated hyperlink destination anchors;
a processor configured to receive a request from a client computer for the facts and confidence information associated with a hyperlink destination anchor;
wherein the processor is configured to retrieve the facts and confidence information associated with a hyperlink destination anchor and to transmit the facts and confidence information to the client computer.

2. A computer readable storage media, containing instructions that are executable by a processor in a client computer to request facts and confidence information about a hyperlink destination anchor, wherein the instructions cause the client computer to:
generate a request to a sever computer of the type having:
a memory that stores facts and confidence information associated with a declarant subscriber and one or more associated hyperlink destination anchors;
a processor configured to receive a request from a client computer for the facts and confidence information associated with a hyperlink destination anchor,
wherein the request includes a hyperlink and wherein the client computer receives the facts and confidence information associated with the hyperlink retrieved by the server computer.

3. The computer readable storage media of claim 2, wherein the instructions cause the processor of the client computer to display the facts and the confidence information for the hyperlink prior to a user clicking on the hyperlink.

4. The computer readable storage media of claim 2, wherein the instructions cause the processor of the client computer to determine if a hyperlink matches a configured regular expression and depending on the match, generate a request to the server computer.

5. A computer system for indicating certified hyperlinks to a user, comprising:
a memory that stores a sequence of programmed instructions;
a processor that is configured to execute the instructions such that when executed, the processor:
generates a request to a sever computer of the type having:
a memory that stores confidence information for one or more facts associated with a declarant subscriber and one or more associated hyperlink destination anchors;
a processor configured to receive a request from a client computer for the confidence information and facts associated with a hyperlink destination anchor,
wherein the request includes a hyperlink and wherein the instructions cause the client computer to receive the confidence information and facts associated with the hyperlink retrieved by the server computer and to display the confidence information and facts to the user.
